(19) United States
(12) Patent Application Publication
(10) Pub. No.: US 2025/0056547 A1
(43) Pub. Date: Feb. 13, 2025

(54) MULTI-SLOT PHYSICAL DOWNLINK CONTROL CHANNEL MONITORING

(71) Applicant: Nokia Technologies Oy, Espoo (FI)

(72) Inventors: Esa Tapani TIIROLA, Oulu (FI); Timo Erkki LUNTTILA, Espoo (FI)

(21) Appl. No.: 18/716,676

(22) PCT Filed: Feb. 11, 2022
(86) PCT No.: PCT/EP2022/053373

§ 371 Date: Jun. 5, 2024

(30) Foreign Application Priority Data
Jan. 5, 2022 (WO) PCT/EP2022/050112

(51) Int. Cl. H04W 72/23; H04W 72/0446

(52) U.S. Cl. CPC H04W 72/23; H04W 72/0446

(57) ABSTRACT

Systems, methods, apparatuses, and computer program products for multi-slot physical downlink control channel (PDCCH) monitoring. A method may include determining that a search space relates to a subcarrier spacing and to multi-slot physical downlink control channel monitoring. The method may also include receiving a search space information element that defines a bitmap that defines a number of slots with monitoring occasions. The method may further include receiving a duration parameter that defines a length of a monitoring window. In addition, the method may include determining actual monitoring slots for each period of the monitoring window. Further, the method may include monitoring a physical downlink control channel corresponding to the search space based on the defined duration parameter.

### CROSS-REFERENCE TO RELATED APPLICATIONS

This application claims priority to International Patent Application no. PCT/EP2022/050112 filed on Jan. 5, 2022. The contents of this earlier filed application are hereby incorporated by reference in their entirety.

### FIELD

Some example embodiments may generally relate to mobile or wireless telecommunication systems, such as Long Term Evolution (LTE) or fifth generation (5G) new radio (NR) access technology, or other communications systems. For example, certain example embodiments may relate to apparatuses, systems, and/or methods for multi-slot physical downlink control channel (PDCCH) monitoring.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, fifth generation (5G) radio access technology or new radio (NR) access technology, NR Rel-17, NR-Advanced, and/or 6G (e.g., for frequency band scenarios greater than 71 GHz). Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include determining that a search space relates to a subcarrier spacing and to multi-slot physical downlink control channel monitoring. The method may also include receiving a search space information element that defines a bitmap that defines a number of slots with monitoring occasions. The method may further include receiving a duration parameter that defines a length of a monitoring window. In addition, the method may include determining actual monitoring slots for each period of the monitoring window. Further, the method may include monitoring a physical downlink control channel corresponding to the search space based on the defined duration parameter.

Other example embodiments may be directed to an apparatus. The apparatus may include at least one processor and at least one memory including computer program code. The at least one memory and computer program code may also be configured to, with the at least one processor, cause the apparatus at least to determine that a search space relates to a subcarrier spacing and to multi-slot physical downlink control channel monitoring. The apparatus may also be caused to receive a search space information element that defines a bitmap that defines a number of slots with monitoring occasions. The apparatus may further be caused to receive a duration parameter that defines a length of a monitoring window. In addition, the apparatus may be caused to determine actual monitoring slots for each period of the monitoring window. Further, the apparatus may be caused to monitor a physical downlink control channel corresponding to the search space based on the defined duration parameter.

Other example embodiments may be directed to an apparatus. The apparatus may include means for determining that a search space relates to a subcarrier spacing and to multi-slot physical downlink control channel monitoring. The apparatus may also include means for receiving a search space information element that defines a bitmap that defines a number of slots with monitoring occasions. The apparatus may further include means for receiving a duration parameter that defines a length of a monitoring window.

In addition, the apparatus may include means for determining actual monitoring slots for each period of the monitoring window. Further, the apparatus may include means for monitoring a physical downlink control channel corresponding to the search space based on the defined duration parameter.

In accordance with other example embodiments, a non-transitory computer readable medium may be encoded with instructions that may, when executed in hardware, perform a method. The method may include determining that a search space relates to a subcarrier spacing and to multi-slot physical downlink control channel monitoring. The method may also include receiving a search space information element that defines a bitmap that defines a number of slots with monitoring occasions. The method may further include receiving a duration parameter that defines a length of a monitoring window. In addition, the method may include determining actual monitoring slots for each period of the monitoring window. Further, the method may include monitoring a physical downlink control channel corresponding to the search space based on the defined duration parameter.

Other example embodiments may be directed to a computer program product that performs a method. The method may include determining that a search space relates to a subcarrier spacing and to multi-slot physical downlink control channel monitoring. The method may also include receiving a search space information element that defines a bitmap that defines a number of slots with monitoring occasions. The method may further include receiving a duration parameter that defines a length of a monitoring window. In addition, the method may include determining actual monitoring slots for each period of the monitoring window. Further, the method may include monitoring a physical downlink control channel corresponding to the search space based on the defined duration parameter.

Other example embodiments may be directed to an apparatus that may include circuitry configured to determine that a search space relates to a subcarrier spacing and to multi-slot physical downlink control channel monitoring. The apparatus may also include circuitry configured to receive a search space information element that defines a bitmap that defines a number of slots with monitoring occasions. The apparatus may further include circuitry configured to receive a duration parameter that defines a length of a monitoring window. In addition, the apparatus may include circuitry configured to determine actual monitoring slots for each period of the monitoring window. Further, the apparatus may include circuitry configured to monitor a physical downlink control channel corresponding to the search space based on the defined duration parameter.

### BRIEF DESCRIPTION OF THE DRAWINGS

For proper understanding of example embodiments, reference should be made to the accompanying drawings, wherein.

FIG. 1 illustrates an example procedure for a gNB generating a physical downlink control channel (PDCCH).

FIG. 2 illustrates an example duration, according to certain example embodiments.

FIG. 3 illustrates example for search space (SS) configuration, according to certain example embodiments.

FIG. 4 illustrates an example flow diagram of a method, according to certain example embodiments.

FIG. 5 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for stage3 multi-slot PDCCH monitoring.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

3^{rd} Generation Partnership Project (3GPP) New Radio (NR) supports NR from 52.6 GHz to 71 GHz. Additionally, 3GPP has carried out changes to NR using existing downlink/uplink (DL/UL) waveform to support operations between 52.6 GHz and 71 GHz. Certain example embodiments described herein may support enhancements to physical downlink control channel (PDCCH) monitoring, including, for example, blind detection/control channel element (CCE) budget, and multi-slot span monitoring.

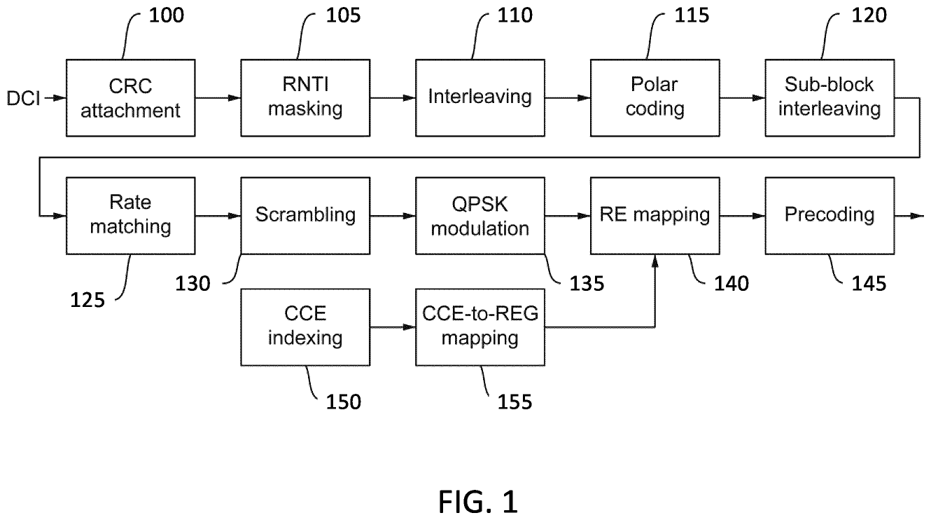

FIG. 1 illustrates an example procedure for a gNB generating a PDCCH. If the size of the DCI format is less than 12 bits, a few zero padding bits may be appended until the payload size equals 12 bits. At 100, for the DCI payload bits, a 24-bit cyclic redundancy check (CRC) may be calculated and appended to the payload. The CRC allows the UE to detect the presence of errors in the decoded DCI payload bits. At 105, after the CRC is attached, the last 16 CRC bits may be masked with a corresponding identifier, referred to as a radio network temporary identifier (RNTI). Using the RNTI mask, the UE can detect the DCI for its unicast data and distinguish sets of DCI with different purposes that have the same payload size. At 110, the CRC attached bits may then be interleaved to distribute the CRC bits among the information bits. The interleaver may support a maximum input size of 164 bits. This means that DCI without CRC can have at most 140 of payload bits. At 115, the bits may then be encoded by a Polar encoder to protect the DCI against errors during transmission. At 120, the encoder output may be processed using a sub-block interleaver, and then at 125, rate matched to fit the allocated payload resource elements (REs) of the DCI.

At 130, the payload bits of each DCI may be separately scrambled by a scrambling sequence generated from the length-31 Gold sequence. The scrambling sequence may be initialized by the physical layer cell identity of the cell or by a UE specific scrambling identity and a UE specific cell RNTI (C-RNTI). At 135, after the scrambled DCI bit sequence is Quadrature Phase Shift Keying (QPSK) modulated, at 140, the complex-valued modulation symbols may be mapped to physical resources in units referred to as control channel elements (CCEs). At 150 and 155, each CCE may include six resource element groups (REGs), where a REG is defined as one PRB in one OFDM symbol which contains nine REs for the PDCCH payload and three demodulation reference signal (DMRS) REs. Additionally, in verifying the number of CCEs at 150, the gNB may adjust the coding rate for PDCCH. For each DCI, 1, 2, 4, 8, or 16 CCEs can be allocated, where the number of CCEs for a DCI is denoted as aggregation level (AL). With QPSK modulation, a CCE may include 54 payload REs and therefore can carry 108 bits. In this case, the output size of the rate matching block may be L·108, where L is the associated AL. Based on the channel environment and available resources, the gNB can adaptively choose a proper AL for a DCI to adjust the code rate. The precoding block (145) may allow the gNB to change the antenna precoder weights between different REG bundles (while maintaining the precoding within the REG bundle). This provides the ability to achieve transmit diversity for the 1-port PDCCH transmission involving more than one Tx antenna.

Furthermore, a DCI with AL=L may be mapped to physical resources in a given BWP, where necessary parameters such as frequency and time domain resources, and scrambling sequence identity for the DMRS for the PDCCH are configured to a UE by means of control resource set (CORESET). In addition, a UE may be configured with up to three CORESETs in 3GPP Rel-15 and up to five CORESETs in 3GPP Rel-16 (for multi-DCI multi-TRP operation) on each of up to four BWPs of a serving cell. In general, CORESETs may be configured in units of six PRBs on a six PRB frequency grid and one, two, or three consecutive OFDM symbols in the time domain.

A DCI of AL=L may include L continuously numbered CCEs, and the CCEs may be mapped on a number of REGs in a CORESET. NR supports distributed and localized resource allocation for a DCI in a CORESET. This may be done by configuring interleaved or non-interleaved CCE-to-REG mapping for each CORESET (255). For interleaved CCE-to-REG mapping, REG bundles constituting the CCEs for a PDCCH may be distributed in the frequency domain in units of REG bundles. A REG bundle is a set of indivisible resources consisting of neighbouring REGs. A REG bundle may span across all OFDM symbols for the given CORESET. Once the REGs corresponding to a PDCCH are determined, the modulated symbols of the PDCCH are mapped to the REs of the determined REGs in the frequency domain first and the time domain second (i.e., in increasing order of the RE index and symbol index, respectively).

The UE may also perform blind decoding for a set of PDCCH candidates. In particular, PDCCH candidates to be monitored may configured for a UE by means of search space (SS) sets. There may be two SS set types: a common SS (CSS) set, which is commonly monitored by a group of UEs in the cell; and UE-specific SS (USS) set, which is monitored by an individual UE. A UE may be configured with up to 10 SS sets each for up to four BWPs in a serving cell. Further, the SS set configuration may provide a UE with the SS set type (CSS set or USS set), DCI format(s) to be monitored, monitoring occasion, and the number of PDCCH candidates for each AL in the SS set.

An SS set with index s may be associated with one CORESET with index p. The UE may determine the slot for monitoring the SS set with index s based on the higher layer parameters for periodicity k, offset o, and duration d, where periodicity k and offset o provide a starting slot and duration d provides the number of consecutive slots where the SS set is monitored starting from the slot identified by k and o.

As to PDCCH monitoring, the mapping of PDCCH candidates of an SS set to CCEs of the associated CORESET may be implemented by means of a hash function. The hash function randomizes the allocation of the PDCCH candidates within CORESET. Furthermore, the UE may be monitoring PDCCH on the certain CORESET based on the activated TCI state of the CORESET. The TCI state may provide the UE with two quasi co-location (QCL)-Type source RSs at carrier frequencies where receive beamforming is applied. One of the source RSs may be the QCL-TypeD source based on which the UE is able to set its receive beam properly. The UE may be able to receive PDCCH with the same RX beam as it used to receive the given QCL-TypeD source RS. Before the UE has been provided TCI state for PDCCH monitoring, the UE may apply the SSB used in the random access.

NR may provide support for overbooking functionality, where a UE can be configured with (temporarily) more PDCCH monitoring than supported by the UE. The UE capability defined separately for different subcarrier spacing (SCS) covers a number of control channel blind decoding attempts (BD) that the UE needs to perform at least, and the number of non-overlapping control channel elements (CCEs) that the UE should be able to demodulate. If the number of BDs/CCEs is exceeded for a certain monitoring occasion, the UE may not need to monitor certain SSs, and they may be dropped (i.e., not monitored).

As to multi-slot monitoring, 3GPP describes certain elements of different PDCCH search space (SS) groups. For example, for group (1) SS, a type 1 common search space (CSS) set is defined with a dedicated radio resource control (RRC) configuration, a type 3 CSS, an a UE specific SS. In group (1) SS, an SS may be monitored within Y consecutive slots within a slot group of X slots. Additionally, the Y consecutive slots may be located anywhere within the slot group of X slots. In some cases, there may be no requirement to align the Y consecutive slots across UEs or with slot n0. In some cases, no may be the first slot where the UE searches the PDCCH for system information block 1 (SIB1) for certain synchronization signal block (SSB) beam. Additionally, the location of n0 with respect to the SSB may be determined by a physical broadcast channel (PBC). Further, the location of the Y consecutive slots within the slot group of X slots may be maintained across different slot groups. In addition, PDCCH blind decoding (BD) attempts for all group (1) SSs may be restricted to fall within the same Y consecutive slots.

3GPP also defines group (2) SS where type 1 CSS set is defined without a dedicated RRC configuration and type 0, 0A, and 2 CSS. Here, SS monitoring locations may be anywhere within a slot group of X slots, with the exception that BD attempts for Type0-CSS for SSB/CORESET 0 multiplexing pattern 1, and additionally for Type0A/2-CSS if searchSpaceId=0, occur in slots with index n0 and n0+X0. Here, no is as in 3GPP Rel-15, and X0=4 for 480 kHz SCS, and X0=8 for 960 kHz SCS.

3GPP also supports combinations of (X,Y). For instance, a UE capable of multi-slot monitoring may support, for SCS 480 kHz, (X,Y)=(4,1). For SCS 960 kHz, the UE may support, for SCS 960 kHz, (X,Y)=(8,1). In other cases, the UE capable of multi-slot monitoring may optionally support, for SCS 480 kHz, (X,Y)=(4,2), and for SCS 960 kHz, (X,Y)=(8,4), (4,2), and (4,1).

In the case where a UE is capable of multi-slot monitoring, the UE may support various elements related to PDCCH monitoring within Y slots. These elements may define, for example, what are the valid OFDM symbols within Y slots for PDCCH monitoring. For instance, for Y>1, FG3-1 (monitoring group (1) SSs in the first 3 orthogonal frequency-division multiplexing (OFDM) symbols of each of the Y slots). For a 960 kHz SCS and Y=1, FG3-5b may be configured with set1=(7,3). Here, the first number is the minimum gap in symbols between the start of two spans, and the second number is the span duration in symbols.

Additionally, for a 480 kHz SCS and Y=1, FG3-5b may be configured with set2=(4,3) and (7,3) with a modification with maximum two monitoring spans in a slot. Here, the first number is the minimum gap in symbols between the start of two spans, and the second number is the span duration in symbols. In some cases, the definitions of FG3-5b and FG3-1 may be superseded by processing one unicast downlink control information (DCI) scheduling DL, and one unicast DCI scheduling UL per slot group of X slots per scheduled component carrier (CC) for frequency division duplex (FDD). Alternatively, definitions of FG3-5b and FG3-1 may be superseded by processing one unicast DCI scheduling DL and 2 unicast DCI scheduling UL per slot group of X slots per scheduled CC for time division duplex (TDD).

Furthermore, 3GPP defines certain limits that may be applicable for multi-slot monitoring within the groups of X slots. For instance, the maximum number of monitored PDCCH candidates per X=4 slots for a DL bandwidth part (BWP) with 480 kHz SCS configuration for a single serving cell may be 20. Further, the maximum number of monitored PDCCH candidates per X=8 slots for a DL BWP with 960 kHz SCS configuration for a single serving cell may be 20. Additionally, the maximum number of non-overlapped CCEs per X=4 slots for a DL BWP with 480 kHz SCS configuration for a single serving cell may be 32, and the maximum number of non-overlapped CCEs per X=8 slots for a DL BWP with 960 kHz SCS configuration for a single serving cell may be 32.

As described in 3GPP, the parameter monitoringSlotPeriodicityAndOffset may be provided. This parameter may relate to slots for PDCCH monitoring configured as periodicity and offset. Additionally, it may correspond to L1 parameters “monitoring-periodicity PDCCH-slot” and “monitoring-offset-PDCCH-slot”. For example, if the value (“monitoring-periodicity-PDCCH-slot”) is s11, it means that the UE should monitor the SS at every slot. However, if the value is s14, it means that the UE should monitor the SS in every fourth slot. Further, “monitoring-offset-PDCCH-slot” may be a configurable integer value that defines the actual slot with PDCCH monitoring (within the period defined by the periodicity). However, certain problems arise in conventional configurations. For example, there may be a limited maximum periodicity (in terms of ms). Additionally, there may be values that are not compatible with multi-slot monitoring, since at least part of the monitoring occasions may be outside of the Y slots. This means that there may be error cases that need specific handling. Furthermore, there may be a limited coexistence with other numerologies (especially 120 kHz SCS). In particular, 120 kHz SCS may be the basic numerology for FR2-2 supported by UEs.

There may be various ways to determine BD/CCE dropping rules. For example, in one approach, BD/CCE dropping may be defined per slot, based on the UE's capabilities. In another approach (defined for URLLC scenarios), the UE may be configured to follow a span-based operation. In a span-based operation, CCE processing and BD capabilities may be defined per span. Further, a span may include up to Y consecutive symbols, and the operation may be defined based on two parameters, X and Y. In particular, X (slots) may be the minimum time separation between the first symbols of two consecutive spans, and Y (slots) may be the maximum duration of the span.

3GPP may include a compromise with the search space (SS) configuration. According to 3GPP, the PDCCH monitoring configuration for the considered scenario may be made by means of a new configuration table (e.g., monitoringSlotPeriodicityAndOffset_R17). This parameter may relate to slots for PDCCH monitoring configured as periodicity and offset. Additionally, it may correspond to L1 parameters “monitoring-periodicity PDCCH-slot” and “monitoring-offset-PDCCH-slot”. For example, if the value (“monitoring-periodicity-PDCCH-slot”) is s11, it means that the UE should monitor the SS at every slot. However, if the value is s14, it means that the UE should monitor the SS in every fourth slot. Further, “monitoring-offset-PDCCH-slot” may be a configurable integer value that defines the actual slot with PDCCH monitoring (within the period defined by the periodicity.

The new configuration table may be constructed by associating the table with the parameter X (i.e., slot group size). Separate tables may be defined for X=4 and X=8 (i.e., for 480 kHz and 960 kHz subcarrier spacing (SCS)). Additionally, the tables may be created based on the existing monitoringSlotPeriodicityAndOffset table by keeping slot periodicities that are multiple of X slots (i.e., 4 slots for 480 kHz, and 8 slots for 960 kHz). The tables may also be created by removing slot periodicities that are not multiples of 4 or 8 slots, for SCS of 480 and 960 kHz, respectively. Furthermore, periodicities may be added to match mointoringSlotPeriodicities (in terms of absolute time) available for 120 kHz SCS, corresponding to X times the periodicity in a 120 kHz case.

For a search space set configuration of multi-slot PDCCH monitoring, the monitoringSlotPeriodicityAndOffset and duration may be appended with “-r17”, and for monitoringPeriodicityAndOffset-r17, the values may represent slots. Further, periodicity values (e.g., 32, 65, 128, 5120, 10240, and 20480) may be added to the existing values in monitoringSlotPeriodicityAndOffset.

The total list of supported periodicity values may include {1,2,4,5,8,10,16,20,32,40,64,80,128,160,320,640,1280,2560,5120,10240,20 480}. For each periodicity value Xp, the candidate value range for the offset O may be {0 . . . . Xp−1} slots. In some cases, there may be no need to introduce the term “Xp” in the specifications, where Xp relates to the actual periodicity value selected (e.g., 320 slots). The configured periodicity at least for Group (1) SSs may be restricted to be an integer multiple of Xs slots.

For duration-r17, the values may represent slots. Additionally, the value range may be {8, 12, . . . , 20476}. Further, the configured duration may be restricted to be an integer multiple of Xs slots at least for Group (1) SSs. For the parameter of monitoringSymbolsWithinSlot, this may be applied to each slot in a slot group configured for multi-slot PDCCH monitoring. In some cases, this parameter may be directly reused from earlier releases.

3GPP also introduces a new parameter monitoringSlotsWithinSlotGroup-r17. This parameter may have a size of 8 bits, and each bit in this parameter may represent a slot in a slot group. A slot in the slot group may be configured for multi-slot PDCCH monitoring if the corresponding bit in the slot group is set to “1”. However, in other configurations, the monitoring symbols in such a slot may be done by monitoring SymbolsWithinSlot. Additionally, the slots indicated in the bitmap may be consecutive at least for Group (1) SSs.

Although 3GPP certain PDCCH monitoring configurations, there is still a challenge in defining duration-r17 such that it is compatible with the working assumptions made for minotiring SlotsWithinSlotGroup-r17. As such, certain example embodiments may address a need to provide details of the offset and to revise the definition of “duration” as described above.

3GPP describes the PDCCH search space configuration. The problem is that the duration is not compatible with a new parameter monitoring SlotsWithinSlotGroup-r17. Although 3GPP provides a definition of the monitoring occasions, it does not describe the cases where duration-r17 does not equal 8 slots. Furthermore, it's noted that the size of bitmap (monitoringSlotsWithinSlotGroup-r17) is always 8 bits, and also when operating according to X=4. According to 3GPP, for each downlink (DL) bandwidth part (BWP) configured for a UE in a serving cell, the UE may be provided by higher layers with S≤10 search space sets, where for each search space set from the S search space sets, the UE may be provided the following by the information element SeachSpace. For instance, the UE may be provided with a search space set index s, 0<s<40, by searchSpaceId. The UE may also be provided with an association between the search space set S and a CORESET p by controlResourceSetId or by controlResourceSetId-v1610. In addition, the UE may be provided with a PDCCH monitoring periodicity of kₛ slots and a PDCCH monitoring offset of oₛ slots, by monitoringSlotPeriodicityAndOffset or by monitoringSlotPeriodicityAndOffset-r17. Further, the UE may be provided with a PDCCH monitoring pattern within a slot, indicating first symbol(s) of the CORESET within a slot for PDCCH monitoring, by monitoring Symbols WithinSlot. The UE may also be provided with a PDCCH monitoring pattern within a group of slots, indicating consecutive slots in the group of slots for PDCCH monitoring, by monitoringSlotsWithinSlotGroup-r17. In addition, the UE may be provided with a duration of Tₛ<kₛ slots indicating a number of slots that the search space set s exists by duration or by duration-r17.

According to certain example embodiments, PDCCH monitoring occasions may be defined for various scenarios. For example, one PDCCH monitoring scenario may be defined with 480 kHz or 960 kHz SCS. This PDCCH monitoring scenario may also be associated with multi-slot capability defined by a combination of (X,Y). In addition, this PDCCH monitoring scenario may be available for SSs configurable by a RRC (i.e., SS group (1)).

In certain example embodiments, duration-r17 (configured by RRC as part of SS configuration) may be defined such that duration-r17 (i.e., Tₛ) is interpreted as the total number of consecutive slots configured by monitoringSlotsWithinSlotGroup-r17. According to certain example embodiments, if duration-r17 is less than or equal to 8 (duration-r17≤8), the UE may determine that a bit(s) up-to “duration-r17” is valid in the bitmap, and may discard the other bit(s). For instance, according to certain example embodiments, duration-r17 may define a number of valid bits in the bitmap. For instance, this parameter may be represented as duration-r17=5 (slots), where 5 first bits of the bitmap (monitoringSlotsWithinSlotGroup-r17) are considered as valid bits. Additionally, 3 last bits of the bitmap may be discarded. According to other example embodiments, if duration-r17 is greater than 8 (duration-r17>8), the UE may create a new bitmap by repeating the monitoringSlotsWithinSlotGroup-r17 such that the length of the new bitmap is K*8≥duration-r17, where K is the repetition factor. The UE may also determine that a bit(s) up-to “duration-r17” is valid in the new bitmap, and may discard the other bit(s).

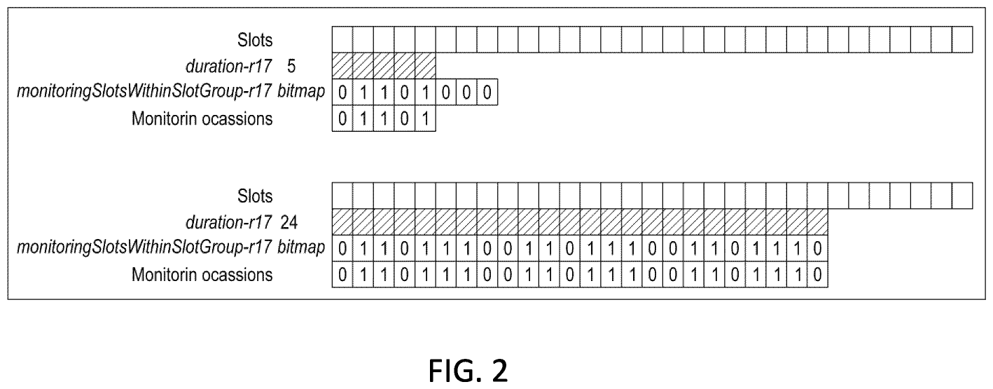

FIG. 2 illustrates an example duration, according to certain example embodiments. As illustrated in the example of FIG. 2, the upper part shows the case where duration-r17 (i.e., Tₛ)=5. In this case, 5 first bits of the bitmap (monitoringSlots WithinSlotGroup-r17) are considered as valid bits. The lower part shows the case where duration-r17=24. In this case, the bitmap defined by monitoring Slots WithinSlotGroup-r17 may be repeated one or more times, (e.g., three times) (duration-r17/8) to obtain a new bitmap.

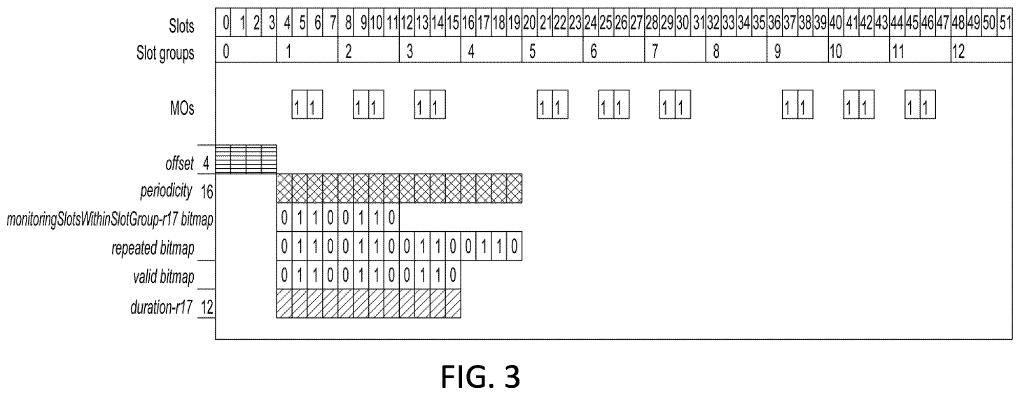

FIG. 3 illustrates an example for SS configuration, according to certain example embodiments. In particular, FIG. 3 illustrates an example applied to an entire multi-slot configuration considering various related parameters. Such parameters may include, for example, offset=4, periodicity=16 slots, monitoring Slots WithinSlotGroup-r17=[0 1 1 0 0 1 1 0], and duration-r17=16 slots. In certain example embodiments, the monitoring occasions (MOs) may be the slots corresponding to “1” in the repeated bitmap that also overlap with the slots indicated by duration-17. In the example of FIG. 3, the bitmap may be repeated twice (K=2), and the size of the valid bitmap=“duration-r17”=12 slots.

Another 3GPP point may relate to details of the offset. For instance, the value range for the offset O may be {0 . . . . Xp−1} slots. However, based on the example illustrated in FIG. 3, the offset may be aligned with the slot group boundary. Doing so may also align monitoring Slots WithinSlotGroup-r17 with the slot group boundaries. Based on that, the value range for offset may be {0, 4, 8, . . . , Xp−1} slots (i.e., the allowed values for the offset may be multiple non-negative integers of the slot group size X). According to certain example embodiments, by removing the unnecessary offset values, it may be possible to reduce the number of signaling bits needed to convey the “offset” (monitoringSlotPeriodicityAndOffset-r17). According to other example embodiments, the UE may consider offset values not aligning with the slot group boundaries as invalid signaling values.

According to certain example embodiments, the UE may determine the valid slots. For instance, the UE may determine that a PDCCH SS relates to 480 kHz or 960 kHz SCS and to multi-slot PDCCH monitoring. The UE may also receive the SS information element via RRC signaling. In particular, according to some example embodiments, the UE may receive an 8-bit monitoringSlotsWithinSlotGroup-r17 relative to a certain predefined reference point (e.g., slot 0 in FIG. 3). In certain example embodiments, the reference point may be defined as the beginning of the radio frame #0. Additionally, the monitoring window may start as defined by the offset, and the length of the monitoring window may be defined by duration-r17. Further, in certain example embodiments, the actual slots to be monitored may not start in the first slot of the monitoring window (provided that the first bit(s) in the bitmap (monitoringSlotsWithinSlotGroup-r17) are zero(s)). In some example embodiments, the offset may be determined as 4*k, where k∈[0, 1, 2, . . . ], or as X*k, where X=4 for 480 kHz SCS, and X=8 for 960 kHz SCS.

In other example embodiments, when receiving the SS information element, the UE may derive periodicity from the monitoringSlotPeriodicityAndOffset. Periodicity may define the time difference between consecutive monitoring windows defined by monitoring SlotsWithinSlotGroup-r17. In further example embodiments, the UE may also receive duration-r17, which defines the length of the monitoring window, and determine the actual monitoring slots for each period.

According to certain example embodiments, the UE may also determine the actual monitoring slots for each period. For example, if the duration (defined by duration-r17) is less than or equal to 8 (duration≤8), the UE may consider up-to “duration-17” bits as valid bits in the bitmap.

According to some example embodiments, if the duration (as defined by duration-r17) is greater than 8 (duration>8), the UE may create a new bitmap by repeating the monitoring Slots WithinSlotGroup-r17, and considering up-to “duration-17” bits as valid bits in the new bitmap. According to other example embodiments, the actual monitoring slots may depend on the size of the slot group X. for example, if the duration is greater than or equal to X (duration-17≤X), the UE may consider up-to “duration” bits as valid bits in the bitmap. However, if the duration is less than X (duration-r17>X), the UE may create a new bitmap by repeating the monitoring SlotsWithinSlotGroup-r17, and consider up-to “duration-17” bits as valid bits in the new bitmap, where X=4 for 480 kHz SCS, and X=8 for 960 kHz SCS.

3GPP may define certain monitoring occasions. However, 3GPP does not define cases where duration-r17 does not equal 8 slots. According to certain example embodiments, for each DL BWP configured to a UE in a serving cell, the UE may be provided by higher layers with S≤10 search space sets where, for each search space set from the S search space sets, the UE may be provided various information elements by SearchSpace. For instance, the UE may be provided with a search space set index s, 0<s<40, by searchSpaceId, an association between the search space set s and a CORESET p by controlResourceSetId or by controlResourceSetId-r16, a PDCCH monitoring periodicity of kₛ slots and a PDCCH monitoring offset of oₛ slots, by monitoringSlotPeriodicityAndOffset or by monitoringSlotPeriodicityAndOffset-r17, a PDCCH monitoring pattern within a slot, indicating first symbol(s) of the CORESET within a slot for PDCCH monitoring, by monitoringSymbolsWithinSlot, a PDCCH monitoring pattern within a group of slots, indicating consecutive slots in the group of slots for PDCCH monitoring, by monitoring Slots WithinSlotGroup-r17, and a duration of Tₛ<kₛ slots indicating a number of slots that the search space set s exists by duration or by duration-r17. In certain example embodiments, if duration-r17 is less than or equal to 8 (duration-r17≤8), the UE may consider up-to “duration-r17” bits as valid bits in the bitmap. However, if the duration is greater than 8 (duration>8), the UE may create a new bitmap by repeating the monitoring Slots WithinSlotGroup-r17, and may consider up-to “duration-r17” bits as valid bits in the new bitmap.

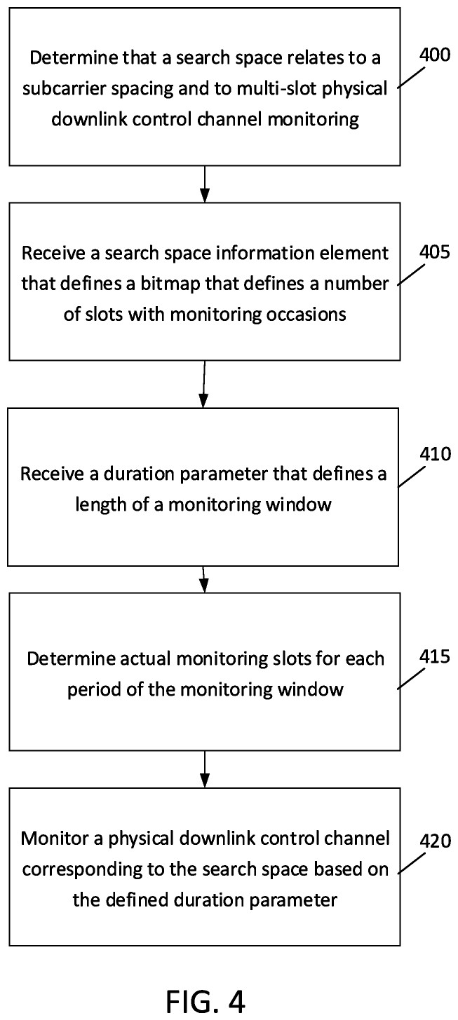

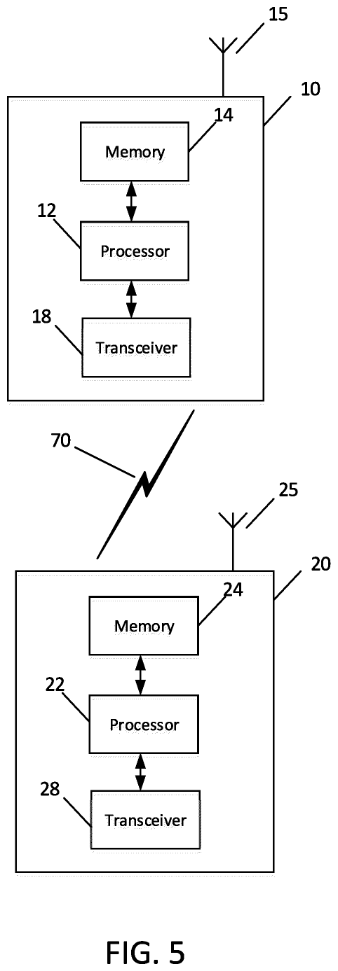

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 5 may be performed by a UE similar to one of apparatuses 10 or 20 illustrated in FIG. 5. Other example embodiments may relate to an integrated access backhaul (IAB) where the UE functionalities may be carried out by the mobile termination (MT) part of the IAB node, and the gNB functionalities may be carried out by the distributed unit (DU) part of the IAB node, respectively.

According to certain example embodiments, the method of FIG. 4 may include, at 400, determining that a search space relates to a subcarrier spacing and to multi-slot physical downlink control channel monitoring. The method may also include, at 405, receiving a search space information element that defines a bitmap that defines a number of slots with monitoring occasions. The method may further include, at 410, receiving a duration parameter that defines a length of a monitoring window. In addition, the method may include, at 415, determining actual monitoring slots for each period of the monitoring window. Further, the method may include, at 420, monitoring a physical downlink control channel corresponding to the search space based on the defined duration parameter.

According to certain example embodiments, the method may further include deriving an offset and periodicity parameter from a monitoringSlotPeriodicityAndOffset parameter which defines the monitoring window relative to a predefined reference point. According to some example embodiments, the number of slots may include up to eight slots. According to other example embodiments, when the duration parameter is less than or equal to eight slots, the method may also include determining bits up-to a number of bits of the duration parameter as valid bits in the bitmap. According to further example embodiments, when the duration parameter is greater than eight, the method may include creating a new bitmap by repeating the bitmap, and considering up-to a number of bits of the duration parameter as valid bits in the new bitmap.

In certain example embodiments, the offset parameter may align a starting position of the monitoring window with a starting position of a slot group X. In some example embodiments, the actual monitoring slots are dependent upon a size of a slot group X. In other example embodiments, when the duration parameter is less than or equal to a duration of the slot group X, the method may also include considering up-to a number of bits of the duration parameter as valid bits in a bitmap. In further example embodiments, when the duration parameter is greater than a duration of the slot group X, the method may further include creating a new bitmap by repeating the bitmap, and considering up-to a number of bits of the duration parameter as valid bits in the new bitmap.

FIG. 5 illustrates a set of apparatuses 10 and 20, according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 5.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 5.

As illustrated in the example of FIG. 5, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-4.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-4.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to determine that a search space relates to a subcarrier spacing and to multi-slot physical downlink control channel monitoring. Apparatus 10 may also be controlled by memory 14 and processor 12 to receive a search space information element that defines a bitmap that defines a number of slots with monitoring occasions. Apparatus may further be controlled by memory 14 and processor 12 to receive a duration parameter that defines a length of a monitoring window. In addition, apparatus 10 may be controlled by memory 14 and processor 12 determine actual monitoring slots for each period of the monitoring window. Apparatus 10 may also be controlled by memory 14 and processor 12 to monitor a physical downlink control channel corresponding to the search space based on the defined duration parameter.

In certain example embodiments, apparatus 20 may be a node, core network element, or element in a communications network or associated with such a network, such as a base station, a Node B, an evolved Node B (eNB), 5G Node B or access point, next generation Node B (NG-NB or gNB), and/or WLAN access point, associated with a radio access network (RAN), such as an LTE network, 5G or NR. It should be noted that one of ordinary skill in the art would understand that apparatus 20 may include components or features not shown in FIG. 5.

As illustrated in the example of FIG. 5, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in one or more of FIGS. 1-3.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in or associated with FIGS. 1-3.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for determining that a search space relates to a subcarrier spacing and to multi-slot physical downlink control channel monitoring. The apparatus may also include means for receiving a search space information element that defines a bitmap that defines a number of slots with monitoring occasions. The apparatus may further include means for receiving a duration parameter that defines a length of a monitoring window. In addition, the apparatus may include means for determining actual monitoring slots for each period of the monitoring window. Further, the apparatus may include means for monitoring a physical downlink control channel corresponding to the search space based on the defined duration parameter.

Certain example embodiments described herein provide several technical improvements, enhancements, and/or advantages. For instance, certain example embodiments may provide small changes in the specifications. According to other example embodiments, a solution may be provided by works for both scenarios of when X=4 and X=8, and for both numerologies supporting multi-slot monitoring. In addition, certain example embodiments may provide added flexibility in PDCCH search space configuration without excessive signaling overhead. Other example embodiments may provide exceptional coexistence with 120 kHz SCS by providing the ability to create flexible time domain pattern behavior for 480/960 kHz SCS, and mimic the time domain pattern available for 120 kHz SCS.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
BD Blind Decoding
BS Base Station
BWP Bandwidth Part
CCE Control Channel Element
CN Core Network
CORESET Control Resource Set
CSS Common Search Space
DL Downlink
eNB Enhanced Node B
FFS For Further Study
FR2-2 Frequency Range 2-2 (57-71 GHz)
gNB 5G or Next Generation NodeB
LTE Long Term Evolution
LPP LTE Positioning Protocol
MO Monitoring Occasions
NR New Radio
PDCCH Physical Downlink Control Channel
QCL Quasi Co-Location
QoS Quality of Service
RRC Radio Resource Control
RS Reference Signal
SCS Subcarrier Spacing
SS Search Space
TCI Transmission Coordination Indicator
TDM Time Division Multiplexing
UE User Equipment
UL Uplink
USS User Specific Search Space Set

1-29. (canceled)

30. A method, comprising:
determining that a search space relates to a subcarrier spacing and to multi-slot physical downlink control channel monitoring;
receiving a search space information element that defines a bitmap that defines a number of slots with monitoring occasions;
receiving a duration parameter that defines a length of a monitoring window;
determining actual monitoring slots for each period of the monitoring window; and
monitoring a physical downlink control channel corresponding to the search space based on the defined duration parameter.

31. The method according to claim 30, further comprising:
deriving an offset from an offset and periodicity parameter which defines a location of the monitoring window relative to a predefined reference point; and
deriving a periodicity from the offset and periodicity parameter.

32. The method according to claim 30, wherein the number of slots comprises up to eight slots.

33. The method according to claim 30, wherein, when the duration parameter is less than or equal to eight slots, the method further comprises:
determining bits up-to a number of bits of the duration parameter as valid bits in the bitmap.

34. The method according to claim 30, wherein, when the duration parameter is greater than eight the method further comprises:
creating a new bitmap by repeating the bitmap; and
considering up-to a number of bits of the duration parameter as valid bits in the new bitmap.

35. The method according to claim 30, wherein the offset parameter aligns a starting position of the monitoring window with a starting position of a slot group X.

36. The method according to claim 30, wherein the actual monitoring slots are dependent upon a size of a slot group X.

37. The method according to claim 36, wherein, when the duration parameter is less than or equal to a duration of the slot group X, the method further comprises:
considering up-to a number of bits of the duration parameter as valid bits in a bitmap.

38. The method according to claim 36, wherein, when the duration parameter is greater than a duration of the slot group X, the method further comprises:
creating a new bitmap by repeating the bitmap; and
considering up-to a number of bits of the duration parameter as valid bits in the new bitmap.

39. An apparatus, comprising:
at least one processor; and
at least one memory comprising computer program code,
the at least one memory and the computer program code are configured, with the at least one processor to cause the apparatus at least to
determine that a search space relates to a subcarrier spacing and to multi-slot physical downlink control channel monitoring;
receive a search space information element that defines a bitmap that defines a number of slots with monitoring occasions;
receive a duration parameter that defines a length of a monitoring window;
determine actual monitoring slots for each period of the monitoring window; and
monitor a physical downlink control channel corresponding to the search space based on the defined duration parameter.

40. The apparatus according to claim 39, wherein the at least one memory and the computer program code are further configured, with the at least one processor to cause the apparatus at least to:
derive an offset from an offset and periodicity parameter which defines a location of the monitoring window relative to a predefined reference point; and
derive a periodicity from the offset parameter.

41. The apparatus according to claim 39, wherein the number of slots comprises up to eight slots.

42. The apparatus according to claim 39, wherein, when the duration parameter is less than or equal to eight slots, the at least one memory and the computer program code are further configured, with the at least one processor to cause the apparatus at least to:
determine bits up-to a number of bits of the duration parameter as valid bits in the bitmap.

43. The apparatus according to claim 39, wherein, when the duration parameter is greater than eight, the at least one memory and the computer program code are further configured, with the at least one processor to cause the apparatus at least to:
create a new bitmap by repeating the bitmap; and
consider up-to a number of bits of the duration parameter as valid bits in the new bitmap.

44. The apparatus according to claim 39, wherein the offset parameter aligns a starting position of the monitoring window with a starting position of a slot group X.

45. The apparatus according to claim 39, wherein the actual monitoring slots are dependent upon a size of a slot group X.

46. The apparatus according to claim 45, wherein, when the duration parameter is less than or equal to a duration of the slot group X, the at least one memory and the computer program code are further configured, with the at least one processor to cause the apparatus at least to:
consider up-to a number of bits of the duration parameter as valid bits in a bitmap.

47. The apparatus according to claim 45, wherein, when the duration parameter is greater than a duration of the slot group X, the at least one memory and the computer program code are further configured, with the at least one processor to cause the apparatus at least to:
create a new bitmap by repeating the bitmap; and
consider up-to a number of bits of the duration parameter as valid bits in the new bitmap.

48. A non-transitory computer readable medium comprising program instructions stored thereon, which when executed by at least one processor, cause an apparatus at least to:
determine that a search space relates to a subcarrier spacing and to multi-slot physical downlink control channel monitoring;
receive a search space information element that defines a bitmap that defines a number of slots with monitoring occasions;
receive a duration parameter that defines a length of a monitoring window;
determine actual monitoring slots for each period of the monitoring window; and
monitor a physical downlink control channel corresponding to the search space based on the defined duration parameter.

49. The computer readable medium according to claim 48, wherein the program instructions stored thereon, when executed by the at least one processor, further cause the apparatus at least to:
derive an offset from an offset and periodicity parameter which defines a location of the monitoring window relative to a predefined reference point;
derive a periodicity from the offset parameter;
wherein the number of slots comprises up to eight slots.
